(19) United States
(12) Patent Application Publication
(10) Pub. No.: US 2009/0079702 A1
(43) Pub. Date: Mar. 26, 2009

(54) Method, Apparatus and Computer Program Product for Providing an Adaptive Keypad on Touch Display Devices

(75) Inventor: Ashley Colley, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/860,701

(22) Filed: Sep. 25, 2007

(51) Int. Cl. G06F 3/041

(52) U.S. Cl. 345/173

(57) ABSTRACT

An apparatus for providing an adaptive keypad on touch display devices may include a processing element. The processing element may be configured to receive an indication of a detection of a touch event invoking an operation related to a text character entry, determine candidate text characters based on the operation, and provide for a display of an adaptive keypad having a size that is variable based on the candidate text characters.

### TECHNOLOGICAL FIELD

Embodiments of the present invention relate generally to user interface technology and, more particularly, relate to a method, apparatus, and computer program product for providing an adaptive keypad search on touch display devices.

### BACKGROUND

The modem communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In many situations, it may be desirable for the user to interface with a device such as a mobile terminal for the provision of an application or service. A user's experience during certain applications such as, for example, web browsing may be enhanced by using a touch screen display as the user interface. Furthermore, some users may have a preference for use of a touch screen display for entry of user interface commands over other alternatives. In recognition of the utility and popularity of touch screen displays, many devices, including some mobile terminals, now employ touch screen displays.

Touch screen devices are now relatively well known in the art, with numerous different technologies being employed for sensing a particular point at which an object may contact or even approach the touch screen display. In an exemplary situation, pressure detection may be sensed over a relatively small area and the detection of such pressure may be recognized as a selection of an object, link, item, hotspot, etc. associated with the location of the detection of the pressure. Other mechanisms are also available including, for example, capacitive sensing which may be able to detect an object approaching the touch screen display. Accordingly, although we will refer herein to a touch screen display, it should be recognized that it is not necessary in all cases for a physical touch of the screen to occur in order to register an input as a touch event.

A familiar mechanism which has been used in conjunction with touch screen displays is a stylus. However, a pen, pencil or other pointing device may often be substituted for a dedicated instrument to function as a stylus. Such devices may be advantageous since they provide a relatively precise mechanism by which to apply pressure that may be detected over a corresponding relatively small area and can therefore be recognized as indicative of a user's intent to select a corresponding object, link, item, hotspot, etc.

Some users may consider it cumbersome to routinely remove or acquire a stylus or other pointing device to utilize a touch screen user interface. Accordingly, touch screen user interfaces have been developed in which a finger can be used to provide input to the touch screen user interface. However, a finger is typically larger than a stylus and therefore, accuracy may be sacrificed when selections are made with the finger on a touch screen display. In order to provide keys that are selectable by a finger with an improved level of accuracy, one solution has been to increase the size of selectable keys or items. Accordingly, particularly in situations where the touch screen user interface is utilized in connection with a device having a relatively small sized display such as a mobile terminal, the size of a keypad that is designed for use with a finger may dominate the display so that less or even no other content may be displayed. For example, when performing a search of a list of content, if a text entry is to be entered using a keypad, the list may be obstructed by the keypad. Moreover, in some cases, due to the size of the keypad, some keys of the keypad may not be capable of display at the same time as the other keys. Thus, numerous key entries may be hidden behind a single key or another coping mechanism may be determined. As such, the user may consider the blockage of the list or other content by the keypad to be a problem that may reduce user enjoyment or even increase user dissatisfaction with a particular application or service.

Accordingly, it may be desirable to provide a mechanism for overcoming at least some of the disadvantages discussed above.

### BRIEF SUMMARY

A method, apparatus and computer program product are therefore provided for providing an adaptive keypad search on touch display devices. In particular, a method, apparatus and computer program product are provided that determine possible next key entries for a given operation, such as a search of content within a list, and to present the keypad on the basis of those keys that are possible entries for the given operation. The keypad may therefore be adaptable in size based on the possible entries. In one exemplary embodiment, the keypad size may be adaptable by eliminating those keys that are not a possibility for the current operation. In another exemplary embodiment, the keypad size may be adaptable by shrinking the size of the keypad based on the keys that are possible entries for the current operation.

In one exemplary embodiment, a method of providing an adaptive keypad search on touch display devices is provided. The method may include receiving an indication of a detection of a touch event invoking an operation related to a text character entry, determining candidate text characters based on the operation, and providing for a display of an adaptive keypad having a size that is variable based on the candidate text characters.

In another exemplary embodiment, a computer program product for providing an adaptive keypad search on touch display devices is provided. The computer program product includes at least one computer-readable storage medium having computer-readable program code portions stored therein. The computer-readable program code portions include first, second and third executable portions. The first executable portion is for receiving an indication of a detection of a touch event invoking an operation related to a text character entry. The second executable portion is for determining candidate text characters based on the operation. The third executable portion is for providing for a display of an adaptive keypad having a size that is variable based on the candidate text characters.

In another exemplary embodiment, an apparatus for providing an adaptive keypad search on touch display devices is provided. The apparatus may include a processing element. The processing element may be configured to receive an indication of a detection of a touch event invoking an operation related to a text character entry, determine candidate text characters based on the operation, and provide for a display of an adaptive keypad having a size that is variable based on the candidate text characters.

In another exemplary embodiment, an apparatus for providing an adaptive keypad search on touch display devices is provided. The apparatus includes means for receiving an indication of a detection of a touch event invoking an operation related to a text character entry, means for determining candidate text characters based on the operation, and means for providing for a display of an adaptive keypad having a size that is variable based on the candidate text characters.

Embodiments of the invention may provide a method, apparatus and computer program product for improving display interface. More specifically, according to one embodiment, touch screen interface performance for use with a finger or other selection object may be improved. As a result, for example, mobile terminal users may enjoy improved capabilities with respect to search operations or other applications involving text character entry that may be used in connection with a touch screen display.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of an apparatus for providing an adaptive keypad search on touch display devices according to an exemplary embodiment of the present invention;

FIG. 3 illustrates a screenshot of an exemplary display prior to initiation of an operation associated with a text character entry according to an exemplary embodiment of the present invention;

FIG. 4 illustrates a screenshot of an exemplary display in which only candidate text characters are displayed in an adaptive keypad according to an exemplary embodiment of the present invention;

FIG. 5 illustrates a screenshot of an exemplary display in which only candidate text characters in view of a previously entered character are displayed in an adaptive keypad according to an exemplary embodiment of the present invention;

FIG. 6 illustrates a screenshot of an exemplary display of an adaptive keypad according to an exemplary embodiment of the present invention;

FIG. 7 illustrates a screenshot of an exemplary display in which the adaptive keypad size is reduced based on the number of candidate text characters according to an exemplary embodiment of the present invention; and

FIG. 8 is a block diagram according to an exemplary method for providing an adaptive keypad search on touch display devices according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

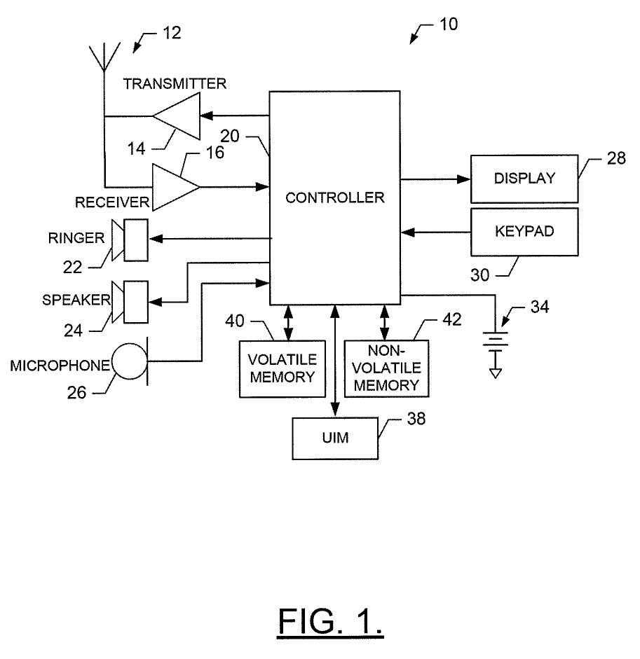

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the apparatus, such as the controller 20, includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a ringer 22, a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

Although an exemplary embodiment of the present invention described below will generally refer to key selection in the context of a search for an item from a list of content items in which a search query is entered in text form, embodiments of the present invention more generally relate to any application in which a text entry may be provided relating to a plurality of items having a text portion. In this regard, the application may include without limitation any of a phonebook, a contact list, a calendar or appointment management application, a gallery, an album, any collection of photos, video, documents, data, etc., or the like. As such, whenever a text entry forming the basis for selecting a particular content item amongst a plurality of content items such as, for example, plain text links, clickable page elements, list or grid items, etc., that include a text portion, embodiments of the present invention may be practiced.

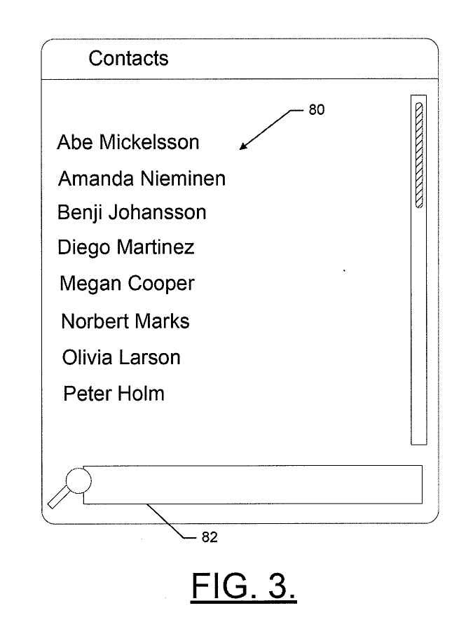

Embodiments of the present invention may involve an operation that may be defined in association with a content item from among a plurality of content items, and the entry of a text portion may be associated with the performance of the operation. Accordingly, for example, in the context of a list of content items, if a search operation associated with the list is performed, the search may be initiated by selecting a particular button or field (e.g., by clicking in a search field 82 shown on FIG. 3) of a display screen. In this regard, by selecting the particular button or field for initiation of the search, a user may be enabled to select a particular key from a keypad that is generated. It is currently common for the keypad generated to be displayed over (and entirely covering in many cases) the list of content items, thereby interfering with the visibility of the list of content items. Moreover, although some conventional techniques have presented possible options for available key choices to be highlighted, enlarged or distinguished from not-possible options, the not-possible options are nonetheless also displayed. Thus, the size of the keypad, and therefore the amount of the list of content items that is obstructed, is typically fixed according to these conventional mechanisms.

However, embodiments of the present invention may provide an adaptable keypad that may provide a keypad having a size that is adjustable based on the possible next characters that may be entered. Moreover, the size of the adaptive keypad of embodiments of the present invention may be further adjustable with each subsequent entry of a text character, based on changes to the possible next characters that may be entered. Thus, for example, for text characters (e.g., which could be numbers, letters, symbols, graphics, etc., in any language, style, font, etc.), a size of the keypad may depend on the number of potential text characters that are possible options for a next entry based on the list of content items. In this regard, the possible options are based on the content items within the list of content items. For example, in a list of three content items including the words “ball”, “car” and “bell”, there would initially only be two possible options for a first letter associated with a search term, which would in this case be the letters “b” and “c”. Accordingly, an adaptive display according to an embodiment of the present invention may only display “b” and “c” as potential key selection options on a keypad (e.g., the keypad may include only two keys, namely “b” and “c”). However, if the letter “c” is selected initially, the keypad may be updated to include only the single possibility of “a” as a second entry option. Meanwhile, if “b” is initially selected, the keypad may be updated to include the new two possible options of “a” and “e”.

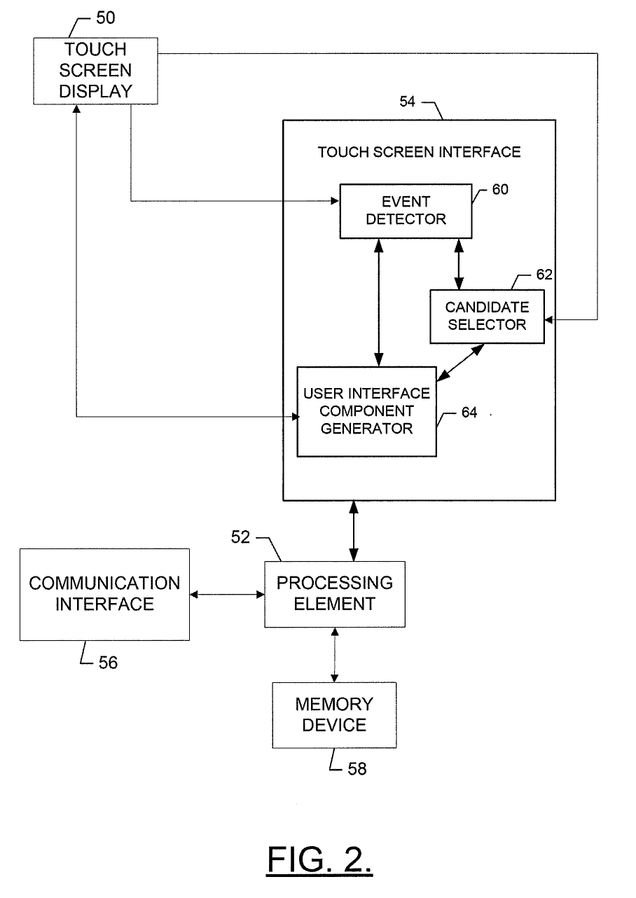

An exemplary embodiment of the invention will now be described with reference to FIG. 2, in which certain elements of an apparatus for providing an adaptive keypad on touch display devices are displayed. The apparatus of FIG. 2 may be employed, for example, in conjunction with the mobile terminal 10 of FIG. 1. However, it should be noted that the apparatus of FIG. 2, may also be employed in connection with a variety of other devices, both mobile and fixed, and therefore, embodiments of the present invention should not be limited to application on devices such as the mobile terminal 10 of FIG. 1. It should also be noted that while FIG. 2 illustrates one example of a configuration of an apparatus for providing an adaptive keypad for touch screen devices, numerous other configurations may also be used to implement embodiments of the present invention.

Referring now to FIG. 2, an apparatus for providing an adaptive keypad search on touch display devices is provided. The apparatus may include or otherwise be in communication with a touch screen display 50 (e.g., the display 28), a processing element 52 (e.g., the controller 20), a touch screen interface 54, a communication interface 56 and a memory device 58. The memory device 58 may include, for example, volatile and/or non-volatile memory (e.g., volatile memory 40 and/or non-volatile memory 42). The memory device 58 may be configured to store information, data, applications, instructions or the like for enabling the apparatus to carry out various functions in accordance with exemplary embodiments of the present invention. For example, the memory device 58 could be configured to buffer input data for processing by the processing element 52. Additionally or alternatively, the memory device 58 could be configured to store instructions for execution by the processing element 52.

The processing element 52 may be embodied in a number of different ways. For example, the processing element 52 may be embodied as a processor, a coprocessor, a controller or various other processing means or devices including integrated circuits such as, for example, an ASIC (application specific integrated circuit). In an exemplary embodiment, the processing element 52 may be configured to execute instructions stored in the memory device 58 or otherwise accessible to the processing element 52. Meanwhile, the communication interface 56 may be embodied as any device or means embodied in either hardware, software, or a combination of hardware and software that is configured to receive and/or transmit data from/to a network and/or any other device or module in communication with the apparatus. In this regard, the communication interface 56 may include, for example, an antenna and supporting hardware and/or software for enabling communications with a wireless communication network.

The touch screen display 50 may be embodied as any known touch screen display. Thus, for example, the touch screen display 50 could be configured to enable touch recognition by any suitable technique, such as resistive, capacitive, infrared, strain gauge, surface wave, optical imaging, dispersive signal technology, acoustic pulse recognition, etc. techniques. The touch screen interface 54 may be in communication with the touch screen display 50 to receive an indication of a touch event at the touch screen display 50 and to modify a response to the indication in certain situations. In particular, the touch screen interface 54 may be configured to modify display properties of the touch screen display 50 with respect to the display of a keypad for selection of a key associated with a text character on the basis of possible text characters that may be entered for a particular operation. In other words, the touch screen interface 54 may be configured to present a display of an adaptive keypad in which a characteristic of the keypad (e.g., size or presence of keys) is adaptable on the basis of which keys are available options with respect to the particular operation. As stated above, the text characters could be numbers, letters, symbols, graphics, etc., in any language, style, font, etc.

The touch screen interface 54 may be any device or means embodied in either hardware, software, or a combination of hardware and software configured to perform the respective functions associated with the touch screen interface 54 as described herein. In an exemplary embodiment, the touch screen interface 54 may be embodied in software as instructions that are stored in the memory device 58 and executed by the processing element 52. Alternatively, touch screen interface 54 may be embodied as the processing element 52 including, for example, being embodied as instructions that are stored in the memory device 58 and executed by the processing element 52.

The touch screen interface 54 may be configured to receive an indication of an input in the form of a touch event at the touch screen display 50. As suggested above, the touch event may be defined as an actual physical contact between a selection object (e.g., a finger, stylus, pen, pencil, or other pointing device) and the touch screen display 50. Alternatively, a touch event may be defined as bringing the selection object in proximity to the touch screen display 50 (e.g., hovering over an object or approaching an object within a predefined distance). In response to detection of a touch event at the touch screen display 50, the touch screen interface 54 may modify a response to the touch event for operations involving the display of options related to text character entry. In this regard, the touch screen interface 54 may include an event detector 60, a candidate selector 62 and a user interface component generator 64. Each of the event detector 60, the candidate selector 62 and the user interface component generator 64 may be any device or means embodied in either hardware, software, or a combination of hardware and software configured to perform the corresponding functions associated with the event detector 60, the candidate selector 62 and the user interface component generator 64, respectively, as described below. In an exemplary embodiment, each of the event detector 60, the candidate selector 62 and the user interface component generator 64 may be controlled by or otherwise embodied as the processing element 52.

The event detector 60 may be in communication with the touch screen display 50 to determine the occurrence of a touch event associated with a particular operation based on each input received at the event detector 60. In this regard, for example, the event detector 60 may be configured to receive an indication of a touch event and may also receive an input or otherwise be aware of a current operation or mode of operation of the apparatus. Accordingly, if the current operation includes or invokes a text character input option, the event detector 60 may detect the touch event invoking an operation related to a text character entry and communicate with the candidate selector 62 to enable or otherwise inform the candidate selector 62 to determine candidate text characters associated with the operation.

In an exemplary embodiment, the touch screen display 50 may provide characteristics of a detection of a touch event such as information indicative of a size of the object touching the touch screen display 50 (e.g., pressure per unit area) as a portion of the information communicated for the indication of the detection. As such, characteristics corresponding to a size of the object touching the touch screen display 50 being above a particular threshold may be designated to correspond to a finger and thereby trigger the event detector 60 to identify the indication of the detection of the touch event as a finger touch event. As another example, the event detector 60 may receive an input indicative of a stylus being sheathed or otherwise stored. Accordingly, if the stylus is stored, the event detector 60 may determine that any object touching the touch screen display 50 is likely a finger. Other mechanisms for determining that the indication of a touch event corresponds to a finger touch (e.g., a touch event associated with a relatively blunt object) or a stylus touch (e.g., a touch event associated with a relatively pointed object) may also be employed such as magnetic, electrical resistance or other techniques. Accordingly, presentation of an adaptive keypad as described herein may only be provided in response to a determination of a finger touch. However, in an alternative embodiment, presentation of the adaptive keypad may be provided regardless of whether a finger or any other object is used to initiate the touch event.

The candidate selector 62 may be configured to determine candidate text characters for an operation related to a text character entry. In this regard, for example, if a search operation is commenced that includes invoking entry of a search query (e.g., a sequence of text characters forming the basis for the search operation), the candidate selector 62 may determine which text characters are possible initial text character entries. For example, if the operation is related to a search of content items in a list or grouping of content items, each of the content items may include a series of text characters defining a title, name, tag, identifier or other identification mechanism associated with each corresponding one of the content items. Thus, a first character of each of the content items may represent a possible text character entry and therefore a candidate text character. A collection of all possible text characters (e.g., all possible first letters of item identifiers) may define the candidate text characters for the operation at the current stage. If the content items are names, for example, from a contact list or phonebook, a first letter of both the first and last name of each contact may be a candidate text character initially.

In an exemplary embodiment, candidate text characters associated with the operation may be re-determined with each additional stage of the operation. In this regard, for example, after each entry of an additional text character, the candidate text characters may be updated or re-determined based on the previous text characters entered and the possible next characters that may be input based, for example, on the sequences of text characters that are being operated on in accordance with the operation. In other words, determining candidate text characters may include, for each entry of a current text character, re-determining candidate text characters based on the currently entered text character and any previously entered text characters based on the possible next characters associated with the identifiers of items in the list of content items.

As such, for example, if a list of content items is being rendered on the touch screen display 50 and a touch event is detected at a particular portion of the touch screen display 50 that corresponds to initiating entry of a query (e.g., a search field), the event detector 60 may communicate such occurrence to the candidate selector 62. According to one example implementation, the candidate selector 62 may then determine the candidate text characters for the operation (e.g., the search) based on possible first characters of items within a list or collection of items being searched. Once the first character has been entered, a new determination of candidate text characters may be determined by the candidate selector 62 based on possible second characters of the items of the list or collection that have the entered first character. The process continues thereafter in similar fashion for the entry of each subsequent text character until, for example, a content item is selected or the search is terminated in another fashion. In some cases, a number or quantity of the candidate text characters may tend to decrease as additional characters are entered, but this is not always the case. After the candidate text characters are determined (or re-determined for each subsequent text character entry related to a particular operation) the candidate text characters are identified or otherwise communicated to the user interface component generator 64.

The component generation element 64 may be configured to generate a modified or alternative user interface component which may be communicated to the touch screen display 50 for visualization at the display based on information received from the candidate selector 62. In this regard, the modified or alternative user interface component may be an adaptive keypad. As such, the component generation element 64 may be configured to provide for a display of the adaptive keypad comprising one or more keys based at least in part on the candidate text characters determined by the candidate selector 62. In an exemplary embodiment, the adaptive keypad may differ from a conventional keypad in a variety of ways. However, according to an exemplary embodiment, the adaptive keypad may include a size that is adaptable based on a quantity or number of the candidate text characters.

In this regard, according to one exemplary embodiment, the size of the adaptive keypad may be adaptable based on a quantity or number of the candidate text characters by eliminating keys from the adaptive keypad that are not candidate text characters. In other words, the adaptive keypad may be presented by the component generation element 64 to only include those characters that are candidate text characters for a particular operation or stage within an operation. Thus, for example, if seventeen letters among the English alphabet are used as a first letter of a first or last name of individuals in a phonebook, and a search operation for an individual in the phonebook is commenced by invoking a text entry for identifying a query term, the adaptive keypad may initially be presented by the component generation element 64 to provide keys only for each of the seventeen letters (i.e., the candidate text characters). The elimination of non-candidate keys may therefore decrease an overall size of the adaptive keypad. In one embodiment, for the example above, seventeen keys may be presented rather than the twenty-six that would otherwise be presented. However, it is not necessary that each candidate text character receive its own key. In this regard, for example, multiple candidate text characters could be associated with a single key or could be hidden behind a particular key. In an exemplary embodiment, the candidate selector 62 could determine a probability associated with each candidate text character defining the likelihood that the candidate text character may follow a current text character and an ordering of the candidate text characters may be provided by the component generation element 64 based on the probability associated with each candidate text character. As such, which candidate text characters are hidden behind a particular key or grouped together on a single key may be determined based on the probability associated with each candidate text character.

By eliminating keys from the adaptive keypad that are not candidate text characters, a size of the adaptive keypad may be adapted by the component generation element 64 corresponding to the number of candidate text characters. Accordingly, for a display of a list of content items that are visible at a first portion of the touch screen display 50, if the adaptive keypad is overlaid over the list, as the size of the adaptive keypad, which may be displayed at a second portion of the touch screen display 50, decreases, a larger portion of the first portion (i.e., more of the list) may become visible. Thus, for example, a size of the first portion may increase correspondingly as a size of the second portion (comprising the adaptive keypad) decreases based on changes to a quantity of the candidate text characters.

As another possibility, rather than eliminating keys that are not candidate text characters, only a size of the adaptive keypad may be altered by the component generation element 64 based on the number or quantity of candidate text characters. For example, the adaptive keypad may include a fixed number of text characters (e.g., the twenty-six English letters, the numbers zero through nine, and/or selected other symbols) and a font size of the text characters and corresponding size of the adaptive keypad may be sized in proportion to a number of candidate text characters. In an exemplary embodiment, the display of the adaptive keypad may include displaying a keypad including a plurality of text characters, of which less than all the text characters are candidate text characters. A size of the keypad may then be determined based on the number of the candidate text characters as compared to the number of the plurality of text characters. In one embodiment, as the number of candidate text characters decreases, the size of the adaptive keypad may decrease proportionally. In other words, the adaptive keypad may shrink in size as the number of candidate text characters decreases. As such, functionality for selecting any particular key among those keys displayed may only be provided for candidate text characters. Text characters that are not candidate text characters, although displayed, may not be selected since such functionality for selection may be removed temporarily. In some embodiments, characters that are candidate text characters could be further distinguished on the basis of color, font, transparency, opacity, or another feature.

In one exemplary embodiment, for example, if the adaptive keypad is set up according to a convention QWERTY keyboard arrangement, a proximity of the candidate text characters may be further considered with respect to shrinking of the size of the adaptive keypad. In this regard, for example, if “a” and “s” are the only two options, a size of the adaptive keypad may be larger than it would be if “a” and “k” were the only two options due to the close proximity of “a” and “s” on the keypad. As another alternative, each candidate text character may have a selection zone defined around the candidate text character, such that the detection of a touch event at a location corresponding to the selection zone may invoke selection of the candidate text character. A size of the selection zone of each character may be based on the number of candidate text characters. Thus, for example, as the number of candidate text characters increases, the size of the selection zone of each character may increase correspondingly. In an exemplary embodiment, an increase in the size of the selection zone may depend upon the proximity of the candidate text character to other candidate text characters. In some embodiments, a size of the selection zone may be further dependent upon a size of the object initiating the touch event, as described above.

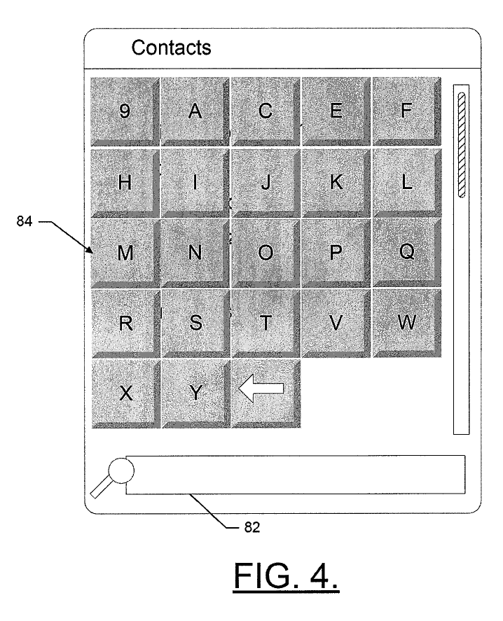

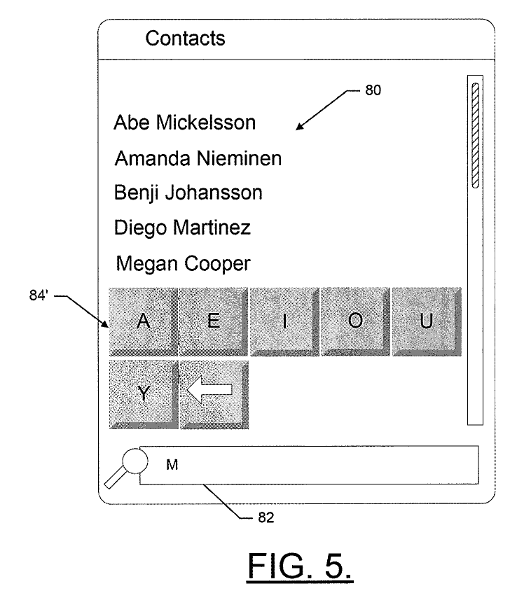

An exemplary embodiment will now be described in reference to FIGS. 3-5, which illustrate exemplary screen shots for explaining operation of an embodiment of the present invention. In this regard, FIG. 3 illustrates a screen shot of a touch screen display including a listing of content items 80. Of note, the content items of FIG. 3 are names (possibly associated with a contact list, phonebook or the like), however, other content items could be provided. Moreover, as shown in FIG. 3, the touch screen display may include a particular field (e.g., search field 82), the selection of which may enable a user to enter text characters for defining a search query. As such, upon clicking in the search field 82, an adaptive keypad 84 may be displayed to permit text entry to define the search query, as indicated in FIG. 4, which illustrates an exemplary adaptive keypad in accordance with an embodiment of the present invention. As shown in FIG. 4, the adaptive keypad 84 according to this embodiment may not include all text characters (e.g., letters A through Z and/or numbers 0 through 9), but instead may only include possible text characters (e.g., candidate text characters) based on the listing of content items 80. Accordingly, based on the present example, only those text characters that correspond with the first letter of either the first or last name of one of the people listed in the listing of content items 80 may be included in the adaptive keypad 84. FIG. 5 illustrates a further example of a modified adaptive keypad 84′, which is modified in response to an entry of a text character. In this regard, the entry of a text character (e.g., the letter “M” in the present example) provides a further limitation to the possible characters that may follow based on the possible second letters of the first or last names of the people listed in the listing of content items 80.

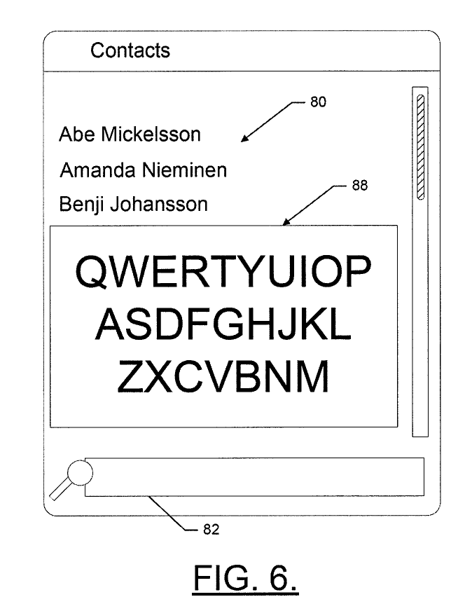

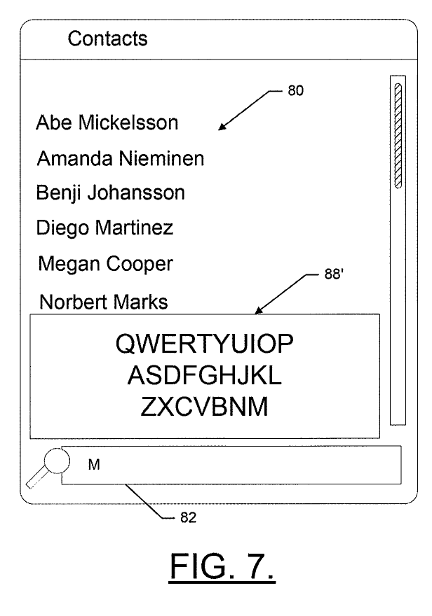

FIGS. 6 and 7 illustrate exemplary screen shots for explaining operation of another embodiment of the present invention. In this regard, FIG. 6 illustrates a screen shot of a touch screen display including the listing of content items 80 and an adaptive keypad 88 that includes text characters arranged in a conventional QWERTY configuration. As indicated in FIG. 6, the adaptive keypad 88 is initially of a size that permits viewing of a small portion of the listing of content items 80. In response to selection of a particular character (e.g., “M” in this example), as shown in FIG. 7, the adaptive keypad 88′ has shrunk in size. Of note, in this embodiment, the adaptive keypad 88′ may be re-sized based on the determination of new candidate text characters (which in this example is a smaller set of possible characters than were available prior to selection of the letter “M”). The size of the adaptive keypad 88′ may be reduced, for example, because less accuracy is required in order to distinguish a selected text character due to the fact that only certain characters (e.g., the candidate text characters) are options for selection.

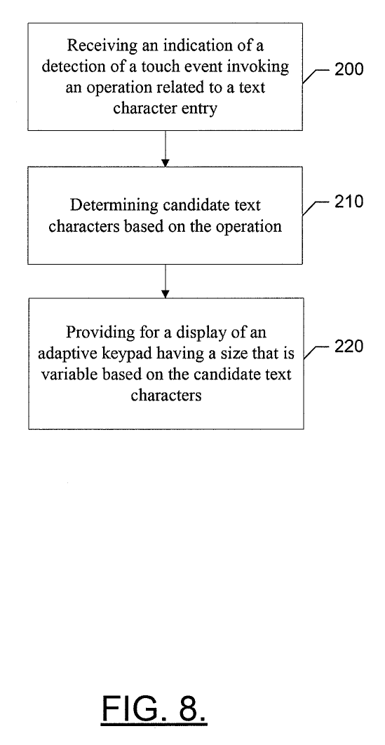

FIG. 8 is a flowchart of a method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In an exemplary embodiment, as illustrated in FIG. 8, a method for providing automatic positioning of text on a touch display device may include receiving an indication of a detection of a touch event invoking an operation related to a text character entry at operation 200. At operation 210, candidate text characters may be determined based on the operation. Provision may be made for a display of an adaptive keypad having a size that is variable based on the candidate text characters at operation 220.

In an exemplary embodiment, operation 200 may include receiving an indication of an initiation of a search operation related to a list of content items. As such, the indication of the initiation of the search operation may include receiving an input of a text character associated with defining a query. In an exemplary embodiment, the method may further include providing for a display of the list of content items at a first portion of a touch screen display and providing for the display of the adaptive keypad at a second portion of the touch screen display. In this regard, for example, a size of the first portion may be increased and a size of the second portion may be correspondingly decreased based on changes to a quantity of the candidate text characters.

In an exemplary embodiment, operation 210 may include, for each entry of a current text character, re-determining candidate text characters based on the currently entered text character and any previously entered text characters of the same query. The size of the adaptive keyboard may then be updated with each subsequent re-determination of candidate text characters.

In another exemplary embodiment, operation 220 may include displaying a keypad including a plurality of text characters, of which less than all the text characters are included in the candidate text characters, and wherein a size of the keypad is determined based on a quantity of the candidate text characters as compared to a quantity of the plurality of text characters. In this regard, for example, a size of the keypad may be shrunk in proportion to a decrease in the quantity of candidate text characters. In another exemplary embodiment, operation 220 may include displaying a keypad including only the candidate text characters. In this regard, a size and/or position of the keys of the keypad may also be determined based on a quantity (i.e., the number) of the candidate text characters.

Additionally, it should be noted that although the preceding description is mainly provided in the context of a touch screen environment, embodiments could also be practiced in other environments as well. As such, a “touch” event could alternatively be provided by a mouse, joystick or other interface device in the form of a “click” or other selection operation.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of a detection of a touch event invoking an operation related to a text character entry;
determining candidate text characters based on the operation; and
providing for a display of an adaptive keypad having a size that is variable based on the candidate text characters.

2. A method according to claim 1, wherein determining candidate text characters comprises, for each entry of a current text character, re-determining candidate text characters based on the currently entered text character and any previously entered text characters of the same query.

3. A method according to claim 2, further comprising updating a size of the adaptive keyboard based on the re-determination of the candidate text characters.

4. A method according to claim 1, wherein receiving the indication of the detection of the touch event invoking the operation comprises receiving an indication of an initiation of a search operation related to a list of content items.

5. A method according to claim 4, wherein receiving the indication of the initiation of the search operation further comprises receiving an input of a text character associated with defining a query.

6. A method according to claim 4, further comprising providing for a display of the list of content items at a first portion of a touch screen display, wherein providing for the display of the adaptive keypad comprises providing for the display of the adaptive keypad at a second portion of the touch screen display.

7. A method according to claim 6, further comprising increasing a size of the first portion and correspondingly decreasing a size of the second portion based on changes to a quantity of the candidate text characters.

8. A method according to claim 1, wherein providing for the display of the adaptive keypad comprises displaying a keypad including a plurality of text characters, of which less than all the text characters are included in the candidate text characters, and wherein a size of the keypad is determined based on a quantity of the candidate text characters as compared to a quantity of the plurality of text characters.

9. A method according to claim 8, wherein providing for the display of the adaptive keypad comprises shrinking the size of the keypad in proportion to a decrease in the quantity of candidate text characters.

10. A method according to claim 1, wherein providing for the display of the adaptive keypad comprises displaying a keypad including only the candidate text characters.

11. A computer program product comprising at least one computer-readable storage medium having computer-readable program code portions stored therein, the computer-readable program code portions comprising:
a first executable portion for receiving an indication of a detection of a touch event invoking an operation related to a text character entry;
a second executable portion for determining candidate text characters based on the operation; and
a third executable portion for providing for a display of an adaptive keypad having a size that is variable based on the candidate text characters.

12. A computer program product according to claim 11, wherein the second executable portion includes instructions for, for each entry of a current text character, re-determining candidate text characters based on the currently entered text character and any previously entered text characters of the same query.

13. A computer program product according to claim 12, further comprising a fourth executable portion for updating a size of the adaptive keyboard based on the re-determination of the candidate text characters.

14. A computer program product according to claim 11, wherein the first executable portion includes instructions for receiving an indication of an initiation of a search operation related to a list of content items.

15. A computer program product according to claim 11, wherein the third executable portion includes instructions for displaying a keypad including a plurality of text characters, of which less than all the text characters are included in the candidate text characters, and wherein a size of the keypad is determined based on a quantity of the candidate text characters as compared to a quantity of the plurality of text characters.

16. A computer program product according to claim 15, wherein the third executable portion includes instructions for shrinking the size of the keypad in proportion to a decrease in the quantity of candidate text characters.

17. A computer program product according to claim 11, wherein the third executable portion includes instructions for displaying a keypad including only the candidate text characters.

18. An apparatus comprising a processing element configured to:
receive an indication of a detection of a touch event invoking an operation related to a text character entry;
determine candidate text characters based on the operation; and
provide for a display of an adaptive keypad having a size that is variable based on the candidate text characters.

19. An apparatus according to claim 18, wherein the processing element is further configured to, for each entry of a current text character, re-determine candidate text characters based on the currently entered text character and any previously entered text characters of the same query.

20. An apparatus according to claim 19, wherein the processing element is further configured to update a size of the adaptive keyboard based on the re-determination of the candidate text characters.

21. An apparatus according to claim 18, wherein the processing element is further configured to display a keypad including a plurality of text characters, of which less than all the text characters are included in the candidate text characters, and wherein a size of the keypad is determined based on a quantity of the candidate text characters as compared to a quantity of the plurality of text characters.

22. An apparatus according to claim 21, wherein the processing element is further configured to shrink the size of the keypad in proportion to a decrease in the quantity of candidate text characters.

23. An apparatus according to claim 18, wherein the processing element is further configured to display a keypad including only the candidate text characters.

24. An apparatus comprising:
means for receiving an indication of a detection of a touch event invoking an operation related to a text character entry;
means for determining candidate text characters based on the operation; and
means for providing for a display of an adaptive keypad having a size that is variable based on the candidate text characters.

25. An apparatus according to claim 24, wherein means for determining candidate text characters comprises, for each entry of a current text character, means for re-determining candidate text characters based on the currently entered text character and any previously entered text characters of the same query.
